(19) United States
(12) Patent Application Publication
(10) Pub. No.: US 2026/0196629 A1
(43) Pub. Date: Jul. 9, 2026

(54) BATTERY MODULE

(71) Applicant: TOYOTA JIDOSHA KABUSHIKI KAISHA, Toyota-shi (JP)

(72) Inventor: Koyo NAGANO, Nisshin-shi (JP)

(73) Assignee: TOYOTA JIDOSHA KABUSHIKI KAISHA, Toyota-shi (JP)

(21) Appl. No.: 19/308,773

(22) Filed: Aug. 25, 2025

(30) Foreign Application Priority Data
Jan. 6, 2025 (JP) 2025-001833

(51) Int. Cl. H01M 50/224; H01M 10/613; H01M 10/625; H01M 10/6551; H01M 10/6554; H01M 50/204; H01M 50/289; H01M 50/30

(52) U.S. Cl. CPC H01M 50/224; H01M 10/613; H01M 10/625; H01M 10/6551; H01M 10/6554; H01M 50/204; H01M 50/289; H01M 50/394; H01M 2220/20

(57) ABSTRACT

A battery module includes: a metal housing including a top plate, a bottom plate, and a peripheral wall connecting peripheral edges of the top plate and the bottom plate; and a plurality of battery cells provided in an internal space of the housing. The housing includes at least one partition wall that connects the bottom plate and the top plate and partitions the internal space into a plurality of housing spaces. At least one of the battery cells is provided in each of the housing spaces. The top plate has through holes.

### CROSS-REFERENCE TO RELATED APPLICATION

This application claims priority to Japanese Patent Application No. 2025-001833 filed on Jan. 6, 2025. The disclosure of the above-identified application, including the specification, drawings, and claims, is incorporated by reference herein in its entirety.

### BACKGROUND

### 1. Technical Field

The present disclosure relates to a battery module.

### 2. Description of Related Art

Japanese Unexamined Patent Application Publication (Translation of PCT Application) No. 2024-508505 (JP 2024-508505 A) discloses a battery module including a battery cell stack formed by stacking a plurality of laminate battery cells, and a housing that houses the battery cell stack.

### SUMMARY

In the battery module of JP 2024-508505 A, if at least one battery cell provided in the housing experiences thermal runaway, heat of this battery cell is likely to be transferred to the other battery cells. That is, the battery module of JP 2024-508505 A is prone to a thermal chain reaction when at least one battery cell experiences thermal runaway.

The present disclosure has been made in view of the above facts, and has an object to provide a battery module that is less likely to cause a thermal chain reaction between a plurality of battery cells provided in a housing when at least one of the battery cells experiences thermal runaway.

A battery module according to a first aspect includes: a metal housing including a top plate, a bottom plate, and a peripheral wall connecting peripheral edges of the top plate and the bottom plate; and a plurality of battery cells provided in an internal space of the housing. The housing includes at least one partition wall that connects the bottom plate and the top plate and partitions the internal space into a plurality of housing spaces. At least one of the battery cells is provided in each of the housing spaces. The top plate has through holes facing the housing spaces.

The metal housing of the battery module according to the first aspect includes at least one partition wall that connects the bottom plate and the top plate and partitions the internal space of the housing into a plurality of housing spaces. At least one of the battery cells is housed in each of the housing spaces. Therefore, when the battery cell provided in one housing space experiences thermal runaway, heat of the battery cell that has experienced thermal runaway is less likely to be transferred to the battery cells housed in the housing space other than the housing space that houses this battery cell. The heat of the battery cell that has experienced thermal runaway is likely to be transferred to the bottom plate via the partition wall and dissipated to the outside of the housing via the bottom plate. The heat of the battery cell that has experienced thermal runaway is discharged through the through hole formed in the top plate to face the housing space. Therefore, in the battery module according to the first aspect, a thermal chain reaction is less likely to occur between the battery cells provided in the housing when at least one of the battery cells experiences thermal runaway.

In a battery module according to a second aspect, in the first aspect, a cooler is in contact with an outer surface of the bottom plate.

In the battery module according to the second aspect, the cooler is in contact with the outer surface of the bottom plate. Therefore, the heat of the battery cell that has experienced thermal runaway is likely to be dissipated to the cooler via the partition wall and the bottom plate.

In a battery module according to a third aspect, in the first or second aspect, the bottom plate, the partition wall, and a pair of side walls that is part of the peripheral wall are provided as an integrally molded product, and the top plate is welded to the side walls.

In the battery module according to the third aspect, the bottom plate, the partition wall, and the side walls that are part of the peripheral wall are provided as the integrally molded product. Therefore, the mechanical strength of the housing can be increased easily.

In a battery module according to a fourth aspect, in the third aspect, the side walls are parallel to the partition wall.

In the battery module according to the fourth aspect, the bottom plate, the partition wall, and the side walls can be manufactured by extrusion.

In a battery module according to a fifth aspect, in the first or second aspect, the housing includes a plurality of the partition walls parallel to each other.

In the battery module according to the fifth aspect, the housing includes a plurality of the partition walls parallel to each other. Therefore, the battery cells can be housed in the housing while being arranged in one direction. That is, many battery cells can be placed in the housing space while effectively utilizing the internal space of the housing.

As described above, the battery module of the present disclosure has the excellent effect that a thermal chain reaction is less likely to occur between the battery cells provided in the housing when at least one of the battery cells experiences thermal runaway.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a battery module according to an embodiment;

FIG. 2 is a schematic exploded perspective view of the battery module; and

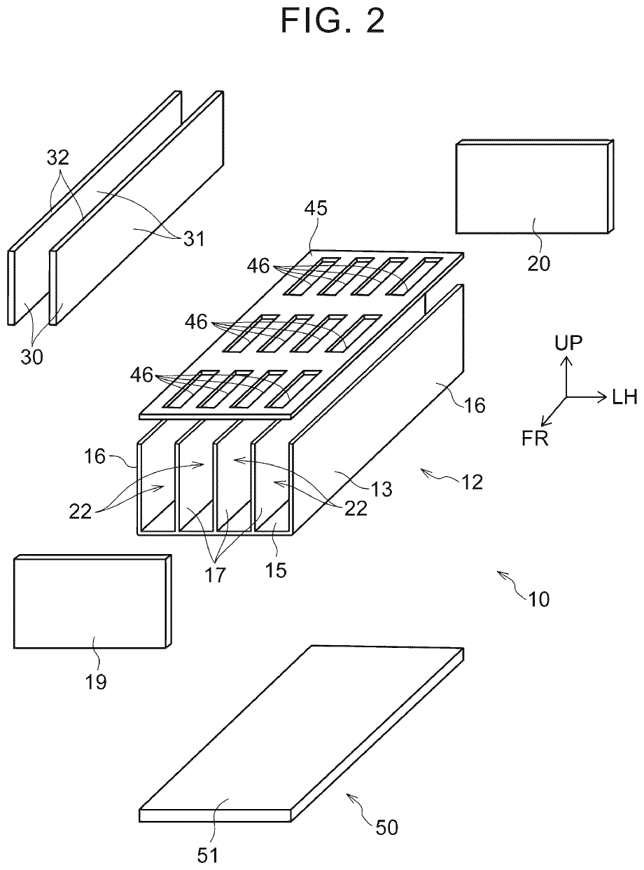

FIG. 3 is a sectional view taken along line 3-3 in FIG. 1.

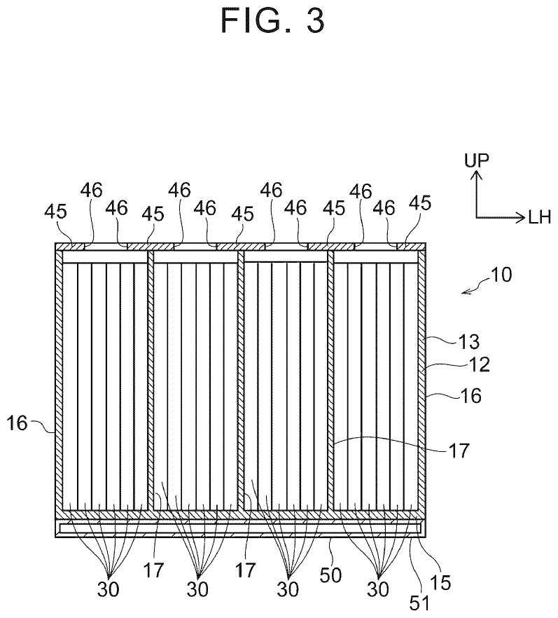

### DETAILED DESCRIPTION OF EMBODIMENTS

A battery module according to an embodiment will be described below with reference to the accompanying drawings. Arrows UP, FR, and LH in each drawing indicate an upper side in an up-down direction of a vehicle, a front side in a front-rear direction of the vehicle, and a left side in a right-left direction of the vehicle, respectively.

A battery module 10 according to the present embodiment is mounted on the vehicle (electrified vehicle). The vehicle according to the present embodiment is a battery electric vehicle.

The battery module 10 according to the present embodiment is housed inside a battery case (not shown) fixed to a vehicle body. For example, electric power of the battery module 10 (battery cells 30) is supplied to an electric motor (not shown) that provides a rotational driving force to drive wheels of the vehicle.

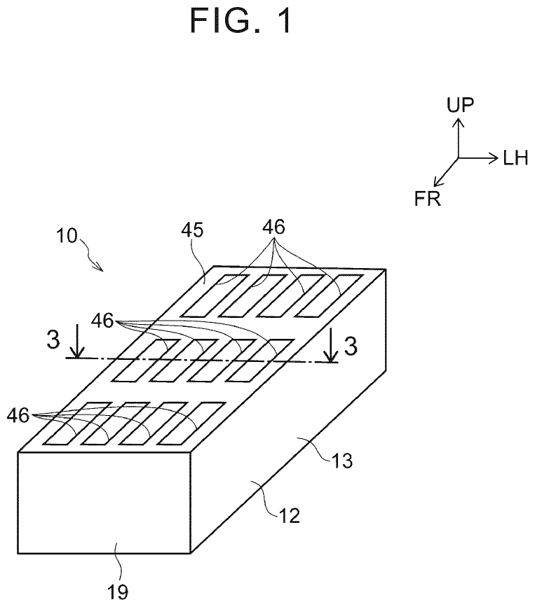

As shown in FIG. 1, the battery module 10 is a substantially rectangular parallelepiped member whose longitudinal direction is the front-rear direction of the vehicle. A module case (housing) 12 that defines the exterior of the battery module 10 is made of an aluminum alloy. The module case 12 includes a case body 13, a front plate (peripheral wall) 19, a rear plate (peripheral wall) 20, and a lid (top plate) 45.

The case body 13 includes a bottom plate 15, a pair of side walls (peripheral walls) 16 extending upward from both right and left side edges of the bottom plate 15, and a plurality of partition walls 17 fixed to the upper surface of the bottom plate 15 and positioned between the right and left side walls 16. All of the bottom plate 15, the side walls 16, and the partition walls 17 are flat plates. The planar shape of the bottom plate 15 is a rectangle with a front-rear dimension larger than a right-left dimension. The side shapes of the side walls 16 and the partition walls 17 are the same rectangles. The side walls 16 and the partition walls 17 are parallel to each other. The bottom plate 15, the side walls 16, and the partition walls 17 have the same front-rear dimensions.

The case body 13 having such a structure is manufactured by extruding an aluminum alloy material using an extruder (not shown). Therefore, both the front and rear sides of the case body 13 manufactured by the extruder are open.

The front plate 19 and the rear plate 20 that are aluminum alloy plates are fixed by welding to the front and rear end faces of the case body 13, respectively. The front shapes of the front plate 19 and the rear plate 20 are the same rectangles. The up-down dimensions of the front plate 19 and the rear plate 20 are the same as those of the side walls 16. The front plate 19 and the rear plate 20 can be manufactured by, for example, press forming.

Housing spaces 22 with open front, rear, and top sides are defined between the bottom plate 15, the side wall 16, the partition wall 17, the front plate 19, and the rear plate 20, and between the bottom plate 15, two adjacent partition walls 17, the front plate 19, and the rear plate 20.

Each laminate battery cell 30 includes a cathode sheet (not shown), an anode sheet (not shown), a separator (not shown), and a laminate film 31. The laminate film 31 includes a left-side component and a right-side component. The outer peripheral edges of the left-side component and the right-side component are welded to form a bag-shaped member. The bag-shaped member covers a laminate including the cathode sheet, the anode sheet, and the separator. Part of the cathode terminal and part of the anode terminal of the laminate are located outside the laminate film 31. The cathode and anode terminals of each battery cell 30 are joined to a busbar (not shown) by laser welding.

A smoke vent portion 32 is formed at the upper edge of the battery cell 30 with such a configuration by welding the upper edge of the left-side component and the upper edge of the right-side component of the laminate film 31. The smoke vent portion 32 is normally closed. That is, the bag-shaped member formed by the laminate film 31 normally seals the cathode sheet, the anode sheet, the separator, and the electrolyte. For example, when an internal short circuit occurs in the battery cell 30 and the internal pressure of the battery cell 30 reaches a predetermined value, the smoke vent portion 32 opens and debris inside the battery cell 30 is discharged to the outside of the battery cell 30 through the smoke vent portion 32. The debris includes, for example, internal electrodes (current collecting terminals), the electrolyte, and gas.

Each housing space 22 of the case body 13 houses a plurality of battery cells 30 arranged in the right-left direction. Adjacent battery cells 30 housed in each housing space 22 are in surface contact with each other. The battery cells 30 located at both the right and left ends out of the plurality of battery cells 30 housed in each housing space 22 are each in surface contact with the side wall 16 or the partition wall 17. The lid 45 that is an aluminum alloy plate is in contact with the upper surfaces of the case body 13, the front plate 19, and the rear plate 20 that house the battery cells 30, busbars, etc. The outer peripheral edge of the lid 45 is fixed to the upper ends of the case body 13 (side walls 16), the front plate 19, and the rear plate 20 by welding. The lid 45 has a plurality of elongated through holes 46. Each through hole 46 faces one of the housing spaces 22 in the up-down direction. The lid 45 can be manufactured by, for example, press forming.

A cooler 50 is provided on the bottom surface of the bottom plate 15 of the case body 13. The cooler 50 is in contact with the entire bottom surface of the bottom plate 15. The cooler 50 includes a case 51 that is a hollow body having a substantially rectangular planar shape, an electric pump, a temperature control device, a tube including both ends connected to the case 51 and a middle part connected to the electric pump and the temperature control device, and a refrigerant that is a liquid filling the case 51 and the tube. When the electric pump is operated, the refrigerant circulates in a predetermined direction inside the case 51 and inside the tube. The temperature control device can remove heat from the refrigerant and add heat to the refrigerant.

### Operations and Effects

Next, the operations and effects of the embodiment will be described.

For example, when an internal short circuit occurs in one of the battery cells 30 of the battery module 10, the internal pressure of this battery cell 30 increases. When the internal pressure of the battery cell 30 reaches a predetermined value, the smoke vent portion 32 of the laminate film 31 opens. That is, the upper edge of the left-side component and the upper edge of the right-side component of the laminate film 31 are separated from each other. Therefore, high-temperature debris inside the battery cell 30 is discharged to the top of the module case 12 via the through holes 46 in the lid 45. At this time, the partition wall 17 prevents the debris from moving toward the adjacent housing space 22. Thus, heat of the battery cell 30 that has experienced thermal runaway is less likely to be transferred to the battery cells 30 housed in the housing space 22 other than the housing space 22 that houses the battery cell 30 from which the debris has been discharged.

The heat of the battery cell 30 that has experienced thermal runaway is likely to be transferred to the bottom plate 15 via the side wall 16 and the partition wall 17. In particular, when the battery cell 30 that has experienced thermal runaway is in direct surface contact with the side wall 16 or the partition wall 17, the heat of the battery cell 30 is likely to be transferred to the bottom plate 15 via the side wall 16 or the partition wall 17. Further, the heat transferred to the bottom plate 15 is absorbed by the cooler 50 having a lower temperature than the bottom plate 15 when the refrigerant cooled by the temperature control device flows inside. Further, the heat transferred to the lid 45 via the side wall 16 and the partition wall 17 is dissipated from the upper surface of the lid 45 to the outside of the module case 12. Therefore, the heat of the battery cell 30 housed in the housing space 22 at the center of the module case 12 in the right-left direction is also likely to be absorbed by the cooler 50 and the lid 45 via the partition wall 17.

Further, the heat of the battery cell 30 that has experienced thermal runaway and part of the debris discharged from the battery cell 30 are discharged to the outside of the module case 12 through the through holes 46 located directly above the housing space 22 that houses the battery cell 30. That is, the module case 12 is less likely to be filled with the debris containing high-temperature gas.

Therefore, in the battery module 10 according to the present embodiment, a thermal chain reaction is less likely to occur between the battery cells 30 provided in the module case 12 when at least one of the battery cells 30 experiences thermal runaway.

Since the case body 13 is an integrally molded product including the bottom plate 15, the side walls 16, and the partition walls 17, the mechanical strength of the case body 13 and the module case 12 can be increased easily.

Since the case body 13 can be manufactured by extrusion, the case body 13 can be manufactured easily.

Further, the case body 13 includes the side walls 16 and the partition walls 17 parallel to each other. Therefore, the battery cells 30 can be housed in the case body 13 while being arranged in one direction (right-left direction). That is, many battery cells 30 can be placed in each housing space 22 while effectively utilizing the internal space of the case body 13 (module case 12).

Although the battery module according to the embodiment has been described above, the design can be modified as appropriate without departing from the spirit and scope of the present disclosure.

For example, the bottom plate 15, the side walls 16, and the partition walls 17 may be manufactured separately, and then the side walls 16 and the partition walls 17 may be fixed to the bottom plate 15 by welding etc.

The cooler 50 may be in contact with any one of the front surface, the rear surface, and the side surface of the module case 12. In this case as well, part of the cooler 50 is preferably in contact with the bottom plate 15. An object having high thermal conductivity (e.g., a thin film sheet) may be provided on the outer surface of the module case 12, and the cooler 50 may be in contact with this object. That is, the cooler 50 may be in contact with the outer surface of the module case 12 indirectly rather than directly.

The number of housing spaces 22 may be any number as long as it is plural.

The number of battery cells 30 housed in one housing space 22 may be one. In this case as well, the battery cell 30 is preferably in surface contact with the side wall 16 or the partition wall 17.

The number, positions, and sizes of the through holes 46 formed in the lid 45 may be different from those described above.

The battery cell 30 may be a type of battery cell other than the laminate type. The battery cell is preferably provided at its upper end with a release valve (safety valve) that opens when the internal pressure of the battery cell reaches a predetermined value.

The module case (housing) 12 may be made of a metal other than aluminum. Examples of such a metal include iron.

The vehicle may be an electrified vehicle other than the battery electric vehicle. For example, the vehicle may be a hybrid electric vehicle or a plug-in hybrid electric vehicle.

What is claimed is:

1. A battery module comprising:
a metal housing including a top plate, a bottom plate, and a peripheral wall connecting peripheral edges of the top plate and the bottom plate; and
a plurality of battery cells provided in an internal space of the housing, wherein the housing includes at least one partition wall that connects the bottom plate and the top plate and partitions the internal space into a plurality of housing spaces,
at least one of the battery cells is provided in each of the housing spaces, and
the top plate has through holes facing the housing spaces.

2. The battery module according to claim 1, wherein a cooler is in contact with an outer surface of the bottom plate.

3. The battery module according to claim 1, wherein:
the bottom plate, the partition wall, and a pair of side walls that is part of the peripheral wall are provided as an integrally molded product; and
the top plate is welded to the side walls.

4. The battery module according to claim 3, wherein the side walls are parallel to the partition wall.

5. The battery module according to claim 1, wherein the housing includes a plurality of the partition walls parallel to each other.
